(19) United States
(12) Patent Application Publication
(10) Pub. No.: US 2001/0027232 A1
(43) Pub. Date: Oct. 4, 2001

(54) Thin-walled conductor track systems comprising at least one thermoplastic

(76) Inventors: Ulrich Haack, Alsvach (DE); Olaf Herd, Munster (DE); Stephan Hoffmann, Neu-Anspach (DE); Rochus Hiekisch, Taunusstein (DE); Peter Radden, Hattersheim (DE)

Correspondence Address: CONNOLLY BOVE LODGE & HUTZ LLP, 1220 MARKET STREET, P.O. BOX 2207, WILMINGTON, DE, 19899, US

(21) Appl. No.: 09/761,314

(22) Filed: Jan. 17, 2001

(30) Foreign Application Priority Data
Jan. 21, 2000 (DE) 10002430.0

(51) Int. Cl. C08F 8/00; C08J 3/00

(52) U.S. Cl. 524/494

(57) ABSTRACT

The present invention relates to thin-walled conductor track systems with a high degree of integration made from at least one thermoplastic polymer, obtainable by preplastifying at least one thermoplastic polymer and placing the plastified material into a press tool in a defined manner, while in the plastic state, and then molding the plastified material in a compression procedure.

The invention relates to thin-walled conductor track systems (printed circuit boards) comprising at least one thermoplastic.

Thin-walled conductor track systems have hitherto been produced in a complicated process using resins which cure. It has not hitherto been possible cost-effectively to produce thin-walled conductor track systems from thermoplastics. In the case of injection-molded thermoplastic components, it is frequently impossible to achieve the required tolerances, such as planarity. This is a function, inter alia, of the strong orientation of the polymer used, the orientation being predetermined by the material itself and by the gate system, and also by gate positioning.

It is an object of the present invention to provide thin-walled, large-surface-area conductor track systems with a high degree of integration, and a cost-effective and environmentally compatible process for their production.

The object of the present invention is achieved by obtaining thin-walled conductor track systems with a high degree of integration made from at least one thermoplastic polymer, by preplastifying at least one thermoplastic polymer and placing the plastified material into a press tool in a defined manner, while in the plastic state, and then molding the plastified material in a compression procedure.

The invention provides the production of thin-walled conductor track systems by the compression process.

The invention opens up a new way of processing using thermoplastics and leading to components which meet more stringent dimensional requirements. In this process, the material is preplastified, and the plastified material is placed into the press tool in a defined manner, while still in the plastic state, and is then molded in a compression procedure. There is therefore no need for complicated downstream operations. In particular, it is possible to produce even complex components with appropriate quality features at low production costs. Another advantage is that the conductor track systems applied to supports made from various materials can be placed in the tool in a defined manner, and that the conductor track systems are subjected to relatively little stress during the compression procedure, a cohesive bond to the base polymer being produced during the process.

It is therefore possible to produce boards, even boards of large surface area, at low cost and with a high degree of integration. Suitable thermoplastic polymers according to the invention are those such as polyamides (PA), aromatic polyamides (PPA), polyether sulfides (PES), polyetherimides (PEI), polyurethanes (PU), polyphenylene sulfides (PPS), polyesters (PBT/PET) or polyether ketones (PEEK, PEK), which may comprise fillers and/or reinforcing materials, such as carbon fiber or glass fiber.

According to the invention, thin-walled conductor track systems may be produced by the compression process. It is possible to produce non-distortion/low-distortion boards, with large surface areas, at low cost and with a high degree of integration. The wall thickness of the thin-walled boards is from 0.1 to 10 mm, preferably from 0.2 to 2.5 mm, particularly preferably from 0.3 to 0.5 mm.

It has proven particularly advantageous to use thermoplastics with a specific viscosity and with long fibers, such as glass fibers or carbon fiber as filler and/or reinforcing material. The process of the invention permits a board of the invention to be produced without stress and with low distortion. Very low tolerances are complied with in the process, even when wall thickness differences are relatively high when comparison is made with injection-molded components. A high degree of integration is therefore achieved. The printed circuit board of the invention has lower weight and higher intrinsic damping. The process of the invention has markedly lower production costs. The process of the invention does not require the downstream operations which are an essential requirement with conventional processes.

1. A thin-walled conductor track system with a high degree of integration made from at least one thermoplastic polymer, obtainable by preplastifying at least one thermoplastic polymer and placing the plastified material into a press tool in a defined manner, while in the plastic state, and then molding the plastified material in a compression procedure.

2. A thin-walled conductor track system as claimed in claim 1, where the thermoplastic polymer comprises one or more polymers, such as polyamides (PA), aromatic polyamides (PPA), polyether sulfides (PES), polyetherimides (PEI), polyurethanes (PU), polyphenylene sulfides (PPS), polyesters (PBT/PET) or polyether ketones (PEEK, PEK), which may comprise fillers and/or reinforcing materials, such as carbon fiber or glass fiber.

3. A thin-walled conductor track system as claimed in claim 1, where the conductor track system has a wall thickness of 0.1 to 10 mm.

4. A thin-walled conductor track system as claimed in claim 1, where the conductor track system has a wall thickness of 0.2 to 2.5 mm.

5. A thin-walled conductor track system as claimed in claim 1, where the conductor track system has a wall thickness of 0.3 to 0.5 mm.

6. A process for producing thin-walled conductor track systems with a high degree of integration made from at least one thermoplastic polymer, where at least one thermoplastic polymer is preplastified and the plastified material is placed into a press tool in a defined manner, while in the plastic state, and is then molded in a compression procedure.
